(19) United States
(12) Patent Application Publication
(10) Pub. No.: US 2019/0322967 A1
(43) Pub. Date: Oct. 24, 2019

(54) BARRIQUE BARREL AND METHOD FOR REUSING A BARRIQUE BARREL OF THIS TYPE

(71) Applicant: rebarriQue Verwaltungs GmbH & Co. KG, Hochstadt (DE)

(72) Inventor: Thomas LUTZ, Bellheim (DE)

(73) Assignee: rebarriQue Verwaltungs GmbH & Co. KG, Hochstadt (DE)

(21) Appl. No.: 16/345,357

(22) PCT Filed: Apr. 7, 2017
(86) PCT No.: PCT/DE2017/100280

§ 371 Date: May 6, 2019

(30) Foreign Application Priority Data
Oct. 28, 2016 (DE) 10 2016 120 684.9

(51) Int. Cl. C12H 1/22; B65D 6/26; C12G 3/07

(52) U.S. Cl. CPC C12H 1/22; C12G 3/07; B65D 9/24

(57) ABSTRACT

A layer that is present on the inner side of barrique barrels, produced by wood toasting, is responsible for sensory enhancement of the wine stored therein. The extraction of these substances, so-called tannins, is greatest in a new barrique barrel and decreases as the barrel is used for a second and third time, thus increasing the storage time. It is not common to use the barrel more than three times. This results in considerable costs and material expenditure for the barrique barrels. In view of this, the aim of the present invention is to provide a barrique barrel that can be reconditioned. For this purpose, barrel staves are joined to form layered rings, which are assembled in layers to form a barrel instead of arranging the staves vertically as in conventional barrels. As the result of a detachable connection between the staves and the layered rings, the barrel can be disassembled and ground on the inside so that the barrel staves can be toasted again and assembled to form a new barrel.

The present invention relates to a barrique barrel having a barrel base and a barrel wall formed from multiple barrel staves joined in a liquid-tight manner, and a method for reusing such a barrique barrel.

Barrique barrels are wooden barrels for aging high-quality wines. Their distinctive feature is an internal roasting of the barrels, so-called toasting, in which the parts of wall that are in contact with the stored wine can impart roasted aromas to the wine.

Oak is rich in low-molecular organic substituents that can be extracted into the wine, and is typically used for the production of barrels. Hydrolyzable polyphenols, including primarily ellagitannins, represent the most important fraction.

It is known that the tannins released during the aging process have a greater influence on the taste of the wine in the first use of a barrique barrel, since they are more plentiful in the toasted wood upon the first use. During the second use, the storage time is thus typically extended, and for this reason the barrels are generally not used past a third time. Although old barrique barrels are frequently used for storing whiskey, the costs for purchasing the barrels are extremely high for winegrowers, and are clearly reflected in the price of the wine. Lastly, the existing tree stock, which does not allow unlimited production of barrique barrels, must also be taken into account.

Against this background, alternatives have already been sought, and include, among others, introducing toasted wood chips into stainless steel drums which impart the roasting aromas to the wine from all sides, or even mixing the roasting aromas in powdered form directly into the wine. At the least, however, such wines, provided that they achieve the aroma of barrique wines at all, cannot be declared as such, so that at the present time there are essentially no alternatives to conventional aging.

On this basis, the object of the present invention is to provide a barrique barrel that can be used more than just three times, without the additional uses adversely affecting the aroma of the wine.

This object is achieved by a barrique barrel according to the features of claim 1. Further meaningful embodiments of such a barrique barrel may be discerned from subclaims 2 through 8. The object is also achieved by a barrique barrel according to the features of independent claim 9 and the refinement according to subclaim 10. Also set forth is a method for reusing a barrique barrel according to the features of independent claim 11, and the refinement according to subclaim 12.

The aim of the invention is to provide a barrique barrel that can be disassembled, so that the individual barrel staves in the disassembled state or in a partial combination may be reconditioned in order to be reused in a barrique barrel. The barrel staves are reconditioned by removing, in particular grinding or planing, the inner side that is in contact with the wine, and then toasting the underlying, still fresh wood again and subsequently reassembling the barrel staves or partial combinations to form a complete barrel. A few millimeters are removed as needed. Alternatively, and fundamentally encompassed by the invention, the barrel is initially assembled and then toasted on the inner side.

For this purpose, a barrique barrel as is common in the prior art should comprise at least a barrel base and a barrel wall, the barrel wall being made up of a plurality of barrel staves that are joined in a liquid-tight manner.

However, on the one hand conventional forms of barrels cannot be disassembled, since during barrel-making they are unnaturally deformed and do not return to their original shape when disassembled. The pressing-together of the barrel staves achieved during barrel-making would thus be absent. On the other hand, as a result of removing the inner walls of the barrel, the individual barrel staves would become too thin and would assume a different shape. Therefore, the invention is also based on a different barrel design.

According to the invention, multiple barrel staves are detachably connected to form a self-contained layered ring, and multiple layered rings are in turn detachably stacked to form a barrel wall. This results in a barrel wall that may be held together on a barrel base, or also between a barrel base and barrel top. In a first approximation, it is sufficient to join the layers together and hold them in position by clamping, collaring, or carcass pressing to establish the stated detachable connection.

Alternatively, a different sequence may be used to join the barrel staves together, by initially joining superposed barrel staves together to form barrel walls, and combining multiple, preferably identical, barrel walls produced in this way to form a barrel wall. Similarly, for disassembly it may be sufficient to separate the walls from one another without breaking them down into individual barrel staves. Continuous barrel walls may also be reconditioned as a whole by grinding, and subsequently toasted.

As a result of this approach, the material used for the barrique barrel may be recycled, so that after a filling, or the customary three fillings, only a thin layer on the inner side of the barrel, not the entire barrel, has to be disposed of. On the one hand this has cost benefits for the barrels, but on the other hand also results in significantly less cutting of oak timber.

For the described design, it is not absolutely necessary, but appears to be particularly advantageous, to form the individual layered rings in a rectangle, i.e., to provide the barrel staves in a long, straight shape. Depending on the desired barrel shape, the barrel staves may have different lengths, heights, and thicknesses; in any case, however, the inner side is altered with each removal in the reconditioning method according to the invention.

In a preferred shape of the barrel staves for rectangular layered rings, an inner area and an outer area of the barrel staves are present, and the areas merge together without a visible boundary. The outer area ends on both sides in a corner leaf, i.e., a cube-shaped protrusion whose overhang width corresponds to its own width, and whose overhang height corresponds to its own height. On one side of the barrel stave the corner leaf is formed on the top, and on the opposite side is formed on the bottom, so that the corner leaves of two identical barrel staves combine to form a corner leaf connection, and may be joined by screw connections on each end-face side.

At the same time, however, the inner area ends in a miter, so that the miter and the corner leaf adjoin one another on both ends of the barrel stave. In this way, in each case two barrel staves may be connected at their outer areas via a corner leaf connection, while the inner areas adjoin one another only with their miters. However, during removal of the inner side, as a result of the miter the inner shape remains the same for each degree of removal. Thus, the barrel staves in combination do not lose seal-tightness due to the removal of the inner side.

If merely pressing the barrel wall by collaring, pressing, or clamping is not considered sufficient, it is also possible to establish connections for the individual barrel staves by means of further connecting means.

Firstly, this may mean that the barrel staves have undercut grooves on the edge at their exterior longitudinal edges, for example cut in the shape of a trapezoid. If two barrel staves lie one on top of the other, with the trapezoidal recesses congruently superposed, they complement one another to form a double trapezoidal recess into which a corresponding double trapezoidal body may be introduced. Such double trapezoidal bodies are known as Hoffmann dovetail keys, for example.

Alternatively or additionally, the barrel staves may have boreholes that pass through the barrel staves transversely, in parallel to the inner side. Threaded rods may be guided through these boreholes over the entire height of the barrel wall, and at their ends are closed off with closure elements such as nuts, heads, wing nuts, and the like. The barrel staves may be braced against one another by tightening the closure elements, so that seal-tightness may also be established in this way. The barrel base and/or the barrel top may also be clamped, if necessary.

The recesses and boreholes for mounting the connecting elements are preferably situated in the outer area of the barrel staves, while the inner area of the connecting means and the receptacles for same are kept free. Thus, upon repeated removal of the inner side, the durability of the connections between the layered rings is not affected, and the inner area is fully available for the removal and for reconditioning the barrique barrel.

With regard to the barrel base, first of all a base made entirely of wood may be provided in order to produce a 100% wooden barrel. However, it is also possible to use a base made, by way of example but not exclusively, of a resin-pressed wood-based product for producing a base plate that is covered with a stainless steel plate. Reconditioning of the base is thus dispensed with.

As an alternative to the layered arrangement of the barrel staves described above, the invention further encompasses a cylindrical barrel design in which the individual barrel staves stand vertically. Unlike conventional wooden barrels, however, the barrel staves are drawn together to form a wall without pretensioning the wood. In addition, detachable connections between the individual barrel staves are established which may be initially detached during disassembly and reconditioning, and then reassembled.

In this regard, it is important that the barrel staves are straight and have a trapezoidal cross section so that targeted removal of a layer on the inner side is possible, and the seal-tightness of the barrel, in particular the outer contours of the individual barrel staves, is/are not changed during removal of the inner side. Only then is it possible within the meaning of the invention to disassemble a barrique barrel, grind it on the inside, and subsequently reassemble it to form a liquid-tight structure. Here as well, toasting of the barrel staves may take place before or after assembly.

The above invention is explained in greater detail below with reference to one exemplary embodiment.

In the drawings,

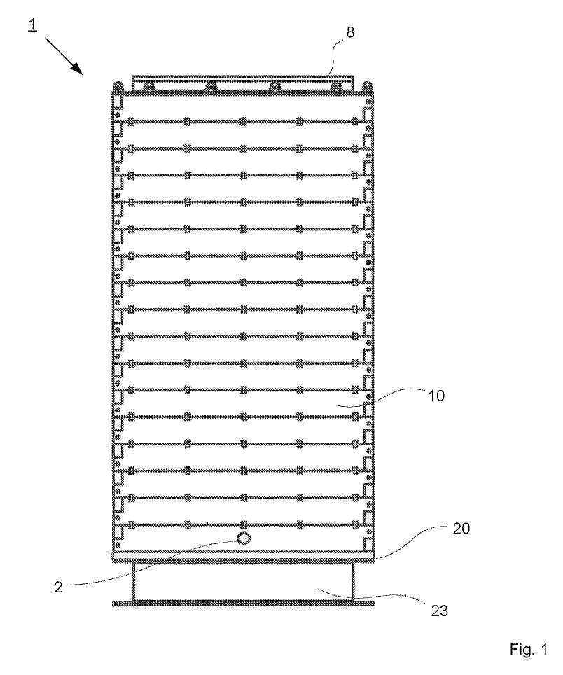

FIG. 1 shows a reconditionable barrique barrel having a barrel wall made up of a plurality of layered rings in a top view from the front,

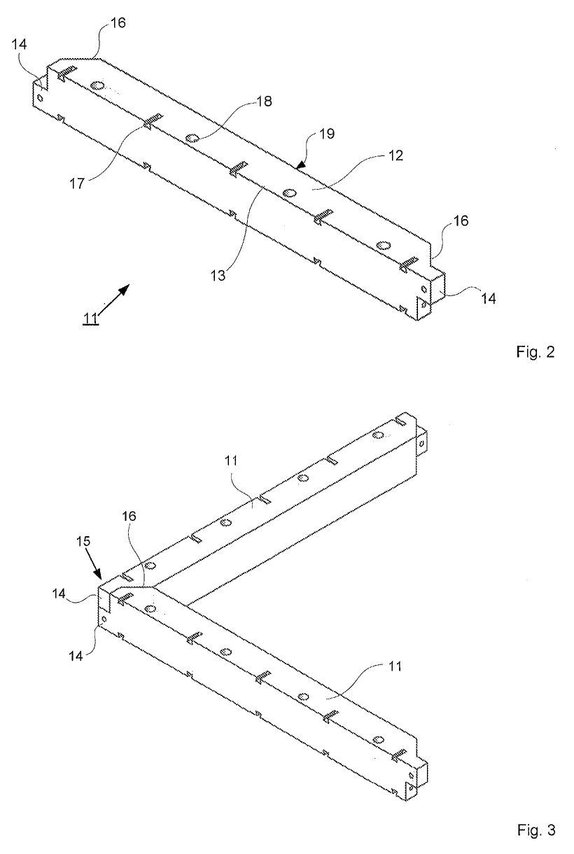

FIG. 2 shows a barrel stave for forming a layered ring, in an oblique perspective illustration from above,

FIG. 3 shows a connection of two barrel staves in an oblique perspective illustration from above,

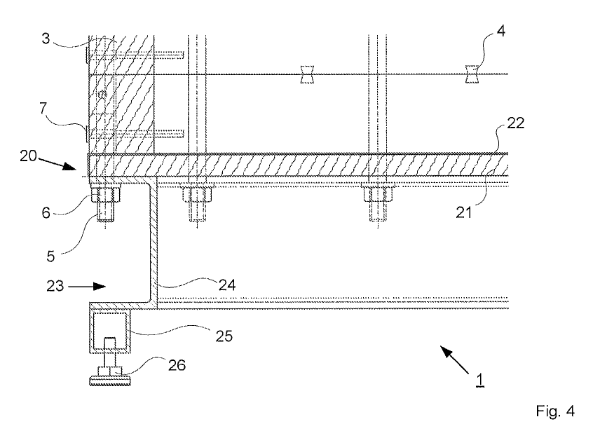

FIG. 4 shows the base area of the barrique barrel according to FIG. 1 in a detail of a frontal cross-sectional illustration, and

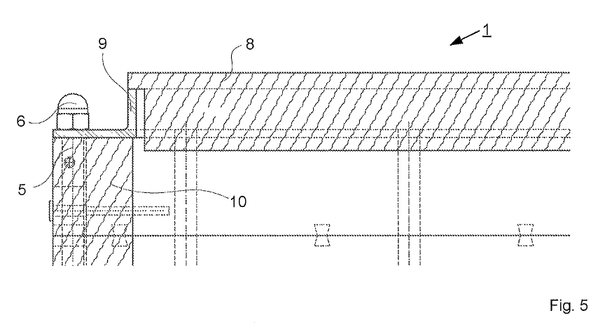

FIG. 5 shows the top area of the barrique barrel according to FIG. 1 in a detail of a frontal cross-sectional illustration.

FIG. 1 shows a barrique barrel 1 constructed of a plurality of layered rings 10. The layered rings 10 in turn are in each case made up of multiple barrel staves that are detachably joined together. For connecting the layered rings 10 to one another, a plurality of threaded rods for clamping all layered rings and a barrel base 20 are provided once, and for connecting adjoining layered rings in each case, clamping is carried out by means of double trapezoidal connectors. These connections are described in greater detail with reference to FIGS. 4 and 5.

The barrique barrel 1 has a drain tap, situated in a lowermost layered ring, for removing the stored wine, and a foundation 23 for elevated storage and for facilitating removal. A barrel top 8 is designed in such a way that it is placed on the barrel and is not fixedly connected thereto in order to also provide access to the interior of the barrique barrel 1 from the top side.

FIG. 2 shows an individual barrel stave 11, which in the present case may be connected to three additional, identical barrel staves 11 to form a square layered ring 10. The barrel stave 11 is made of oak, is long and straight, and in the present case has an oppositely facing inner side 19 whose surface is roasted, i.e., “toasted.” In the properly designed state of the barrique barrel 1, this inner side 19 faces toward the wine.

The barrel stave 11 is divided lengthwise into an inner area 12 and an outer area 13 that smoothly merge into one another. The outer area 13 ends at the end-face sides of the barrel stave 11 in a corner leaf 14, the corner leaves 14 at the ends being offset relative to one another. Identical barrel staves may thus be joined together without having to pay special attention to where a particular barrel stave is used during the assembly of a barrique barrel 1. In contrast to the outer area 13, the inner area 12 ends at the end-face sides of the barrel stave 11, but in a miter, not in a corner leaf. It is thus possible to remove the entire inner side 19 during reconditioning of the barrique barrel without leaving protrusions at the edges, in order to ensure seal-tightness at the edges.

The barrel stave 11 has trapezoidal recesses 17 that extend into the outer area 13, and which represent undercut grooves having a trapezoidal cross section. Two superposed barrel staves 11 complement their respective trapezoidal recesses 17 to form double trapezoidal recesses into which connecting elements in the form of double trapezoids 4 may be introduced. This is illustrated in greater detail in FIGS. 4 and 5.

To be able to drive the threaded rods, shown in FIG. 1, through the barrel wall 3, the barrel staves 11 also have boreholes 18 in the outer area 13, which via multiple superposed barrel staves complement one another to form a continuous insert channel for the threaded rods 5.

FIG. 3 shows two assembled barrel staves 11 in which the corner leaves 14 overlap in a form-fit manner, and the miter 16 continues this form-fit connection in the direction of the inner side. In the outer area 13, the resulting corner leaf connection 15, with a screw connection 7 not shown in greater detail in FIGS. 4 and 5, ensures a force-fit connection within the layered ring 10, while in the direction of the inner side the form fit results in a tight connection of the barrel staves 11.

FIG. 4 shows the base area of the barrique barrel 1, which in the present case is formed by a resin-impregnated plate that forms a wooden base 21. This plate is covered by a stainless steel plate 22, which in this design comes into contact with the wine, whose aroma is not affected. Therefore, reconditioning does not refer to the barrel base 20 here.

To allow removal, the barrel base 20 is set on a foundation 23 that is made up of a circumferential C profile 24, at the inner side of which the threaded rods 5 also exit from the barrel wall 3 and are locked. The C profile 24 in turn rests on a rectangular profile 25 in which pedestals 26 are situated.

FIG. 4 also shows the double trapezoids 4, which are introduced into the corresponding trapezoidal recesses 17 of the barrel staves. The double trapezoids hold the threaded rods 5 as well as the barrel wall 3 together. The screw connections 7 ensure that adjacent barrel staves 11 of a layered ring 10 are joined together.

Lastly, FIG. 5 shows the area of the barrel top 8, which in the present case is placed on an L profile 9. The L profile 9 rests on an uppermost layered ring 10, and the threaded rods 5 extend through both the L profile 9 and the layered rings 10. A closure element 6 in the form of a cap nut tensions the threaded rod 5 against the C profile 24, thus pressing the barrel staves 11 of the barrel wall 3 against one another in a liquid-tight manner.

The above description thus involves a reconditionable barrique barrel whose barrel staves are assembled in layers and allow repeated removal of their inner side, so that repeated toasting of the inner side and significantly increased usage are made possible.

### LIST OF REFERENCE NUMERALS

1 barrique barrel
2 drain tap
3 barrel wall
4 double trapezoid
5 threaded rod
6 closure element
7 screw connection
8 barrel top
9 L profile
10 layered ring
11 barrel stave
12 inner area
13 outer area
14 corner leaf
15 corner leaf connection
16 miter
17 trapezoidal recess
18 borehole
19 inner side
20 barrel base
21 wooden base
22 stainless steel plate
23 foundation
24 C profile
25 rectangular profile
26 pedestal

1. A barrique barrel having a barrel base (20) and a barrel wall (3) formed from multiple barrel staves (11) joined in a liquid-tight manner,
wherein multiple essentially straight barrel staves (11), toasted on an inner side (19), are detachably connected to one another to form self-contained, at least substantially rectangular layered rings (10), which in turn are detachably joined together in a liquid-tight manner and thus form the barrel wall (3).

2. The barrique barrel according to claim 1, wherein the barrel staves (11) have an inner area (12) and an outer area (13), wherein the inner area (12) extends toward the ends into a miter (16) in each case, and the outer area (13) extends toward the ends into a corner leaf (14) in each case.

3. The barrique barrel according to claim 2, wherein two adjacent barrel staves (11) of a layered ring (10) are joined together at their ends by means of a corner leaf (14), the corner leaf connection (15) being situated on the outer side of the layered ring (10), and a miter adjoining the corner leaf connection (15) in the direction of the layered ring interior.

4. The barrique barrel according to claim 2, wherein two adjacent layered rings (10) are connected by means of connecting elements, in the form of a double trapezoid (4), which are introduced into a double trapezoidal recess formed from two congruently arranged peripheral trapezoidal recesses (17) of two adjacent barrel staves (11).

5. The barrique barrel according to claim 2, wherein the barrel wall (3) is clamped between the barrel base (20) and an uppermost layered ring (10), or between the barrel base (20) and a barrel top (8), by means of connecting elements in the form of threaded rods (5) that pass through the layered rings (10) along the height and that are provided on at least one side with a detachable closure element (6).

6. The barrique barrel according to claim 4, wherein the connecting elements are situated in the outer area (13) of the barrel staves (11) and keep the inner area (12) of the barrel staves (11) free.

7. The barrique barrel according to claim 1, wherein the barrel base (20) is formed from a resin-pressed wood-based product and is covered, at least in sections, with a stainless steel plate (22).

8. A method for reusing the barrique barrel (1) according to claim 1, wherein the detachable connections between the layered rings (10) and between the individual barrel staves (11) are detached, the individual barrel staves (11) are ground on their inner side (19) and reassembled to form layered rings (10), which in turn are detachably reassembled to form a liquid-tight barrel wall (3), the barrel staves (11) being toasted again on their inner side (19) before or after assembly.

9. A method for reusing the barrique barrel (1) according to claim 2, wherein the detachable connections between the barrel staves (11) of the individual layered rings (10), but not the superposed barrel staves (11), are detached, the resulting barrel walls are ground on their inner side (19) in combination and are detachably reassembled to form a liquid-tight barrel wall (3), the barrel staves (11) being toasted again on their inner side (19) before or after assembly of the barrel walls to form a barrel wall (3).

10. The method according to claim 9, wherein the reuse of the inner area (12) of the barrel staves (11) up to the point of complete consumption is iterated by repeated removal of the toasted inner side (19) of the inner area (12) and retoasting of the new inner side (19) resulting from the grinding.
